(19) United States
(12) Patent Application Publication
(10) Pub. No.: US 2011/0175840 A1
(43) Pub. Date: Jul. 21, 2011

(54) INTERACTIVE AMBIENCE CREATING SYSTEM

(75) Inventor: Jonathan David Mason, Eindhoven (NL)

(73) Assignee: Koninklijke Philips Electronics N.V.

(21) Appl. No.: 13/119,814

(22) PCT Filed: Sep. 17, 2009
(86) PCT No.: PCT/IB09/54064

§ 371 Date: Mar. 18, 2011

(30) Foreign Application Priority Data
Sep. 23, 2008 (EP) 08164901.4

(51) Int. Cl. G06F 3/041

(52) U.S. Cl. 345/173

(57) ABSTRACT

An interactive ambience creating system comprising a touch sensitive globe configured to generate a signal representing a geographical region based on touch by a user, an information processing unit configured to receive the generated signal and obtain information corresponding to the touched geographical region and a control unit configured to adapt at least one output device in accordance with the obtained information to create an ambience corresponding to the touched geographical region is disclosed. The disclosed system can be used in controlling the atmosphere preferably in a hotel context where language and/or mental models may differ between guests from different cultures.

### FIELD OF THE INVENTION

The present subject matter relates to an interactive ambience creating system.

### BACKGROUND OF THE INVENTION

Patent document WO2008/032237 discloses a system for selecting and controlling light settings. An interactive method and system include a card including scene data, a reader configured to read the scene data, and a processor configured to activate at least one controllable device in accordance with the scene data to provide a scene associated with the scene data. The controllable device, such as a light source and/or a projector/display is activated in response to inserting the card into a slot of the reader or placing card on a surface of the reader. The processor is configured to allow for adjustment of attributes of the scene by a user, including changing intensity and/or color of the scene or of the controllable devices that provide the scene.

Generally, most scenes are based on the mood or emotion of the user (e.g. happy, excited) or on their activity such as working, reading or cooking. The disadvantage of this mode of scene setting can be that one person's idea of a happy scene may be radically different to that of another person. This may be especially true when these scenes are used in a hotel context; differences of opinion will differ even more as cultural aspects get added. The users may have differing opinions of what the scenes should be like; does a ‘cosy’ scene to one person feel like a cosy scene to another?

Hence, it would be advantages to have an interactive ambience creating system that can provide an intuitive way of creating the desired ambience in a room.

### SUMMARY OF THE INVENTION

Accordingly, the present subject matter preferably seeks to mitigate, alleviate or eliminate one or more of the above mentioned disadvantages singly or in combination. In particular, it may be seen as an object of the present subject matter to provide an intuitive interactive ambience creating system that can aid the user in creating a desired ambience in the room.

This object and several other objects are obtained in a first aspect of the present subject matter by providing an ambience creating system comprising
a touch sensitive globe configured to generate a signal representing a geographical region based on touch by a user;
an information processing unit configured to receive the generated signal and obtain information corresponding to the touched geographical region; and
a control unit configured to adapt at least one output device in accordance with the obtained information to create an ambience corresponding to the touched geographical region.

The present subject matter provides a new way of controlling an atmosphere or setting scenes preferably in a hotel environment where language or mental models may differ between guests from different cultures. The term guest or user here refers to a visitor to whom hospitality is extended preferably a customer of a hotel. The term guest and/or user have the same meaning in the context of the present disclosure. All guests have one thing in common; they come from the same planet. Climates that are associated with parts of the world are unlikely to differ between guests and thus can be used as a metaphor for controlling a room's ambience. Therefore, when the guest selects a country, output devices in a room will change their settings to suit accordingly based on a preset representing the climate of the selected country. As an illustrative example, should the guest select a Scandinavian country, the room will be lit with blues and turquoises to represent the cold climate and the lakes of Norway. The temperature in the room would drop a couple of degrees; a cooling breeze may be generated; the sound of rain could start or should the guest wish some ABBA could start playing. However, should the guest wish to feel warm he should select a warm country such as Australia, Egypt, Hawaii, but each would have subtly different atmosphere dynamics.

Hotels may provide a differentiating service or luxury by offering sophisticated yet easy-to-access ambience creating system that enables many different guests to derive a greater sense of belongingness, personalization and pleasure from the same hotel room where the ambience of the room is changeable.

The disclosed ambience creating system provides an easy to use intuitive user interface without texts or icons. There can be no language issues, no cultural issues, and no menu issues. Further, there can be no complexity issues. The disclosed ambience creating system can be used as an educational tool.

In an embodiment, the information processing unit is configured to
access a database/memory and obtain predetermined information corresponding to the touched geographical region; and/or
access Internet and obtain information corresponding to the touched geographical region.

The information processing unit can be directly connected to the database or to a memory. The memory can include all types such as RAM, ROM. The information processing unit can further include software that can interact with the database/memory and obtain information corresponding to the touched geographical region. It is also possible to obtain real time information about the touched geographical region by accessing the information on the Internet. The guest can therefore find out what the weather is like around the world and use it to define the ambience in his room.

In a further embodiment, the information processing unit is configured to obtain at least one of:
weather condition data
climate condition data
atmosphere condition data
data on lighting conditions
cultural related data
environmental and/or nature related data
time data preferably time zone, time of the day
   corresponding to the touched geographical region. Ambience can be considered as a mix of light, temperature, sound and scenes. Hence, obtaining the above information can aid in creating an ambience that can enhance the experience of the guest. The guest in the hotel room can easily obtain the time zone and related information about his home country. When staying away from the home country, the guest can touch his home country and get information about e.g. time, weather, news etc. As an illustrative example, if the guest is in The Netherlands and if the guest wants to call a supplier in China, the guest can press China on the touch sensitive globe and see what time it is and then act accordingly.

In a still further embodiment, touch by the user comprises at least one of:
touching the required geographical region by a finger/stylus
placing a pawn/key on the required geographical region.

This embodiment has the advantage that the guest need not have to control a number of switches. Further it provides an easy to use touch interface.

In a still further embodiment, the control unit is configured to control at least one of the following output devices:
illumination/lighting device
heating device
air conditioning device
fan
audio device
video device
scene generating device
   This has the advantage that the touch sensitive globe can simplify the control of many previously independent devices. Further, it is easy to remember the settings e.g. it is easy to remember a location on the globe rather than lots of numbers of positions of dials on individual devices.

In a still further embodiment, the touch sensitive globe is configured to illuminate (e.g. using glowing lights) the touched geographical region. Feedback regarding which area of the touch sensitive globe is illuminated is important. Illuminating the touched geographical region can attract the guest's attention to the globe. Further, the guest can investigate its function and learn how it is used. The learning process can be short. The guest needs to only select a region to see the effect in the room's ambience. Further, the geographic region the guest selected can remain illuminated until another geographic region is selected so that the guest can easily see and remember what he has selected.

In a still further embodiment, the ambience created is disabled and a default ambience is created in response to at least one of
removing the pawn/key from the geographical region
touching the illuminated geographical region using a finger/stylus
switching off the globe
   This embodiment provides an easy and intuitive way of disabling the created ambience and setting a default ambience. Further in the hotel context this can also happen automatically once the user checks out of the room. When the guest returns to his room, the touch sensitive globe could remember or indicate the guest about the previous selection so that it is easy to find again. Further, it is also possible to provide auto reset to default between old and new guests.

In a still further embodiment, the interactive ambience creating system further comprises:
a sun sphere coupled with the touch sensitive globe, the sun sphere being smaller in size compared to the touch sensitive globe and disposed on a rotation axis parallel to the rotation axis of the touch sensitive globe and substantially away from the touch sensitive globe and wherein
the information processing unit is further configured to determine the position of the sun sphere in relation to the touched geographical region and obtain information related to the time of the day/night; and
the control unit is further configured to adapt at least one output device to create an ambience representing the obtained time of the day/night.

The globe can be accompanied by another sphere that represents the sun. The guest can further adjust the ambience in the room by rotating the earth about its axis (or the sun sphere (or moon sphere) about its axis) and depending on where their selected geographical region is in relation to the sun sphere, the control unit can alter the theoretical time of day and thus the ambience accordingly. As an illustrative example, the guest can adjust the ambience to represent a Scandinavian morning, noon, sunset or night.

In a still further embodiment, positioning the globe such that the touched geographical region is behind the sun sphere activates the control unit to create an ambience that represents night. The amount of light in the room can be suitably controlled by the guest and provides an intuitive simple to use interface. Further, the existing mental models of day, night, time, climate, geography etc. which are unlikely to change greatly between guests can be well made use of.

In a still further embodiment, the information processing unit is further configured to manually receive additional information from the user and the control unit is further configured to adapt at least one output device and create an ambience based on i) the information obtained corresponding to the touched geographical region and ii) manually received additional information from the user. This allows the user to freely alter some of the settings independently in addition to the information obtained corresponding to the touched geographical region and tailor make the required ambience. As an illustrative example, in the hotel context the touch sensitive globe can only control the main lighting and atmosphere. The guest can be free to alter some of the functional lighting independently. As a further illustrative example, if the guest in the UK selected “Australia” the day and night times of these two countries are different and the guest may not want all the lights in the room to be turned off. In such a scenario, the guest can manually control the ambience in association with the predetermined settings of the touched geographical region.

In a still further embodiment, the touch sensitive globe is configured as a two dimensional electronic mat or as a two dimensional touch screen coupled with a pawn to select a geographical region and generate the signal representing the selected geographical region.

The touch sensitive globe can be a two dimensional surface. This can take the form of a touch screen or an electronic mat. A special pawn with magnetic coils can be used to select a country or region. To turn off the ambience the guest could use another pawn to select ‘on/off’ or remove the pawn from the mat. While this embodiment does not include “sun” as the aforementioned touch sensitive globe interface, this mat interface can have additional ‘time of day’ controls that can provide similar functionality.

Further, in the hotel context, the pawn can be the hotel key. This would work in a similar fashion to the existing hotel key card which is normally placed in a slot near the door to turn the lights on or off; however, in this embodiment the user can place the key pawn on the mat and use it to select a country/geographical region.

In a second aspect of the present subject matter, an interactive ambience creating method is disclosed. The method comprises:
employing a touch sensitive globe and generating a signal representing a geographical region based on touch by a user;
receiving the generated signal and obtaining information associated with the touched geographical region; and
activating at least one output device in accordance with the obtained information to create an ambience associated with the touched geographical region.

### BRIEF DESCRIPTION OF THE DRAWINGS

These and other aspects, features and advantages will be further explained by the following description, by way of example only, with reference to the accompanying drawings, in which same reference numerals indicate same or similar parts, and in which:

FIG. 1 schematically illustrates an exemplary interactive ambience creating system according to an embodiment of the present subject matter;

FIG. 2 schematically illustrates another exemplary interactive ambience creating system comprising a touch sensitive globe provided on a two dimensional electronic mat;

FIG. 3 schematically illustrates another exemplary interactive ambience creating system according to a further embodiment of the present subject matter; and

FIG. 4 schematically illustrates an exemplary embodiment of an interactive ambience creating method according to the present subject matter.

### DETAILED DESCRIPTION OF THE EMBODIMENTS

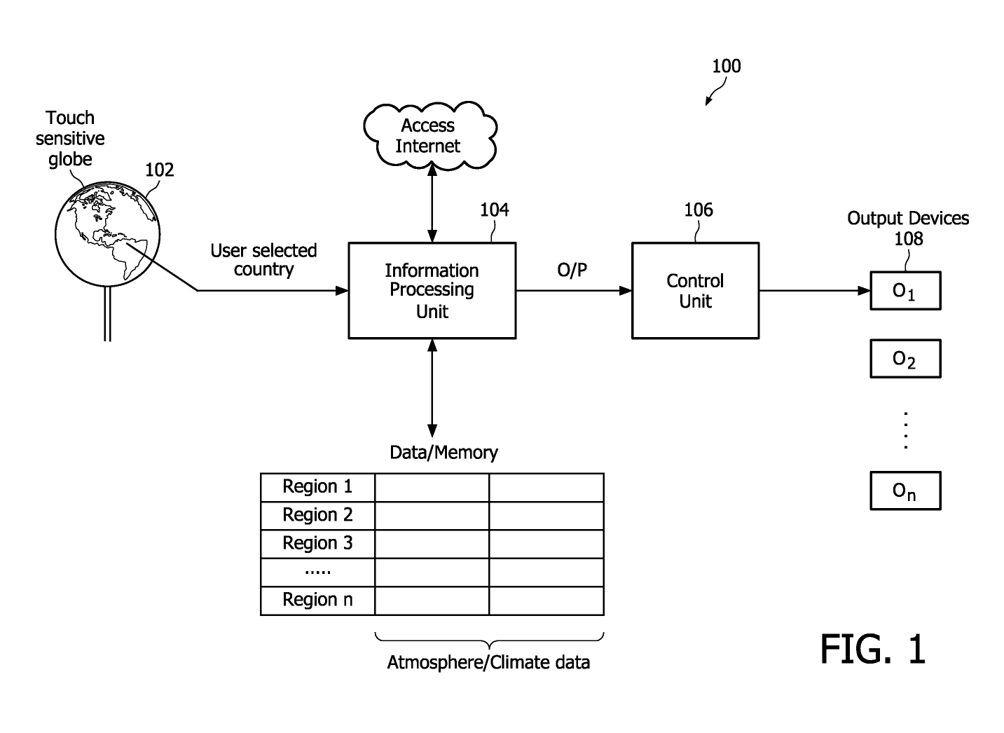

Referring now to FIG. 1, the interactive ambience creating system 100 comprises:

i. a touch sensitive globe 102

ii. an information processing unit 104

iii. a control unit 106

iv. a plurality of output devices 108

The touch sensitive globe 102 here refers to a sphere on which a map especially of the earth is represented. The touch sensitive globe 102 generally looks like the planet Earth. The guests can touch the surface of the globe using a finger or stylus or a pawn and select a particular geographical region/location/country that the guest wishes the atmosphere to represent.

The information processing unit 104 accesses the database (or memory) and retrieves information corresponding to the touched geographical region in response to the selection of the geographical region (e.g. country). It is also possible to configure the information processing unit 104 to access the Internet and obtain real time information about the weather/atmosphere via the Internet. The guest can find out what the weather is like around the world and use it to define the atmosphere in his/her room.

Further, the information processing unit 104 can be configured to obtain at least one of:
weather condition data
climate condition data
atmosphere condition data
data on lighting conditions
cultural related data
environmental and/or nature related data
time data preferably time zone, time of day
   corresponding to the touched geographical region. The obtained information can be used to control at least one output device. The output device 108 can include
illumination/lighting device
heating device
air conditioning device
fan
audio device
video device
scene generating device
   Furthermore, the touch sensitive globe can be configured to illuminate the touched geographical region. Illuminating the touched geographical region can attract the guest's attention to the touch sensitive globe. Further, the guest can investigate its function and learn how it is used. The learning process can be short. The guest needs to only select a geographical region to see the effect in the room's ambience. Further, the geographic region the guest selected can remain illuminated until another geographic region is selected so that the guest can easily see and remember what he has selected.

The ambience created can be disabled and a default ambience can be created in response to at least one of
removing the pawn/key from the geographical region
touching the illuminated geographical region using a finger/stylus
switching off the globe.

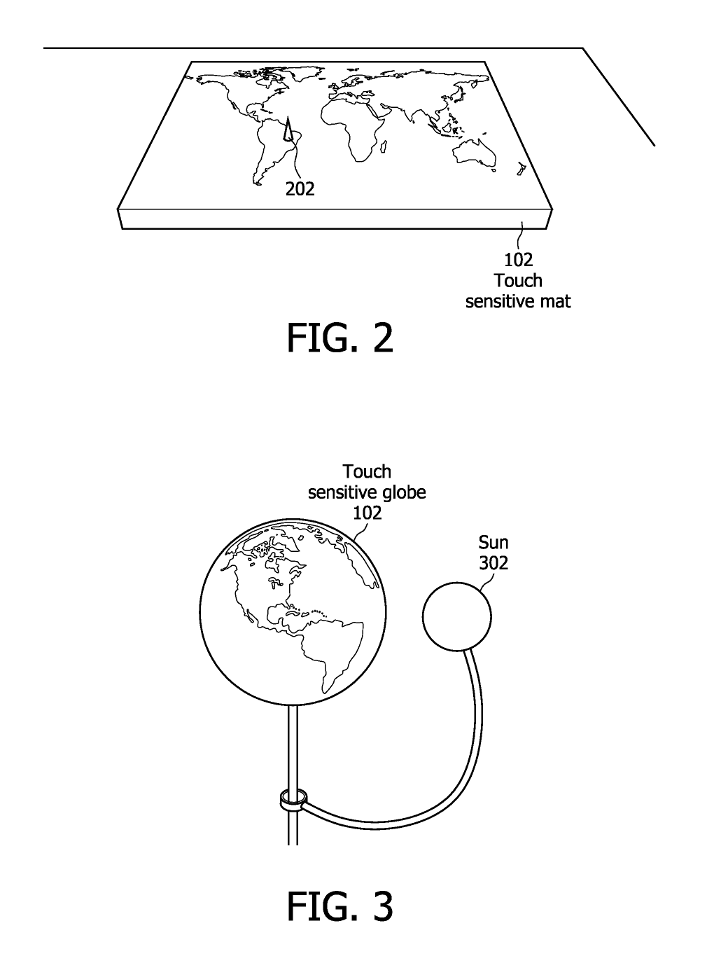

Referring now to FIG. 2, the touch sensitive globe can be configured as a two dimensional electronic mat or as a two dimensional touch screen coupled with a detachable pawn to select a geographical region and generate the signal representing the selected geographical region. The touch sensitive globe can take the form similar to that of a tag tiles game. A special pawn 202 with magnetic coil can be used to select a country or region. To turn off the lights, the guest can use another pawn to select on/off or remove the pawn from the mat. In a hotel context, the pawn could be the hotel key. This would work in a similar fashion to the existing hotel key card which is normally placed in a slot near the door to turn the lights on/off. However, in the present disclosure the guest can be allowed to place the key on the mat and use it to select a country/region/location.

Referring now to FIG. 3, the touch sensitive globe can be accompanied by an additional sphere 302 that represents the sun (or the moon). The guest can further adjust the atmosphere in the room by rotating the touch sensitive globe 102 (i.e. the earth) about its axis and depending on where the selected country/geographical region is in relation to the sun sphere 302, the theoretical time of the day can be altered and thus the atmosphere. Alternately, the sun sphere can be moved about its axis. To this end, the information processing unit 104 can be configured to determine the position of the sun sphere in relation to the touched geographical region and obtain information related to the time of the day/night. Further, the control unit can be further configured to adapt at least one output device to create an ambience representing the obtained time of the day/night. As an illustrative example, the guest can adjust the atmosphere to represent a Scandinavian morning, sunset or night.

Further, positioning the touch sensitive globe such that the touched geographical region is behind the sun sphere 302 can activate the control unit to create an ambience that represents night.

Furthermore, the information processing unit 104 can be further configured to manually receive additional information from the guest. The control unit can be further configured to adapt at least one output device and create an ambience based on i) the information obtained corresponding to the touched geographical region and ii) manually received additional information from the user. Thus, the amount of light in the room can be controlled manually by the guest; for example, if the guest in the UK selected ‘Australia’, the day and night times of these two countries are different and the guest may not want all the lights in the room to turn off.

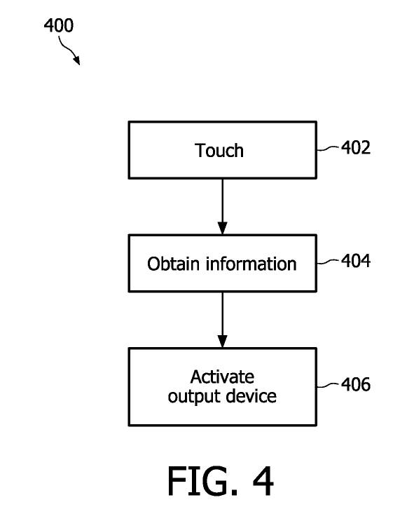

Referring now to FIG. 4, the ambience creating method comprises the following steps:

Step 402 of employing the touch sensitive globe 102 and generating signal representing a geographical region based on touch by a user,

Step 404 of receiving the generated signal and obtaining information corresponding to the touched geographical region, and

Step 406 of activating at least one output device in accordance with the obtained information to create an ambience corresponding to the touched geographical region.

In general, the prior art of configuring the information processing unit to access Internet or access the database/memory, configuring the control unit and other hardware units can be consulted to provide example of how to incorporate them into the disclosed system. Such information is known to the art and is not set forth in detail.

In summary, an interactive ambience creating system is disclosed. The ambience creating system comprises a touch sensitive globe configured to generate signal representing a geographical region based on touch by a user, an information processing unit configured to receive the generated signal and obtain information corresponding to the touched geographical region and a control unit configured to adapt at least one output device in accordance with the obtained information to create an ambience corresponding to the touched geographical region. The disclosed system can be used in controlling the atmosphere preferably in a hotel context where language and/or mental modes may differ between guests from different countries. Hotels may provide a differentiating service or luxury by offering sophisticated yet easy-to-access ambience creating system that enables many different guests to derive a greater sense of belongingness, personalization and pleasure from the same hotel room where the ambience of the room is changeable.

The present subject matter can be used in the context of the home; education such as in schools to inform students of the climates around the world or can be used in retail stores or in creating required ambience in any closed door environment.

Although claims have been formulated in this application to particular combinations of features, it should be understood that the scope of the disclosure of the present subject matter also includes any novel features or any novel combination of features disclosed herein either explicitly or implicitly or any generalization thereof, whether or not is relates to the same subject matter as presently claimed in any claim and whether or not it mitigates any or all of the same technical problems as does the present subject matter.

Further, while the subject matter has been illustrated in detail in the drawings and foregoing description, such illustration and description are to be considered illustrative or exemplary and not restrictive; the subject matter is not limited to the disclosed embodiments. Other variations to the disclosed embodiments can be understood and effected by those skilled in the art of practicing the claimed subject matter, from a study of the drawings, the disclosure and the appended claims. As an example, the touch sensitive globe can be rotated about its axis automatically and can be used as an abstract time piece if an internal clock were present. Further, a single unit may fulfill the functions of several items recited in the claims. The mere fact that certain measures are recited in mutually different dependent claims does not indicate that a combination of these measures cannot be used to advantage.

Use of the verb “comprise” and its conjugates does not exclude the presence of elements other than those stated in a claim or in the description. Use of the indefinite article “a” or “an” preceding an element or step does not exclude the presence of a plurality of such elements or steps. The figures and description are to be regarded as illustrative only and do not limit the subject matter. Any reference sign in the claims should not be construed as limiting the scope.

1. An interactive ambience creating system comprising:
a touch sensitive globe configured to generate a signal representing a geographical region based on touch by a user;
an information processing unit configured to receive the generated signal and obtain information corresponding to the touched geographical region; and
a control unit configured to adapt at least one output device in accordance with the obtained information to create an ambience corresponding to the touched geographical region.

2. The interactive ambience creating system as claimed in claim 1, wherein the information processing unit is configured to
access a database/memory and obtain predetermined information corresponding to the touched geographical region; and/or
access Internet and obtain information corresponding to the touched geographical region.

3. The interactive ambience creating system as claimed in claim 1, wherein the information processing unit is configured to obtain at least one of:
weather condition data
climate condition data
atmosphere condition data
data on lighting conditions
cultural related data
environmental and/or nature related data
time data preferably time zone, time of day
corresponding to the touched geographical region.

4. The interactive ambience creating system as claimed in claim 1, wherein touch by the user comprises at least one of:
touching the required geographical region by a finger/stylus
placing a pawn/key on the required geographical region.

5. The interactive ambience creating system as claimed in claim 1, wherein the control unit is configured to control at least one of the following output devices:
illumination/lighting device
heating device
air conditioning device
fan
audio device
video device
scene generating device

6. The interactive ambience creating system as claimed in claim 1, wherein the touch sensitive globe is configured to illuminate the touched geographical region.

7. The interactive ambience creating system as claimed in claim 1, wherein the ambience created is disabled and a default ambience is created in response to at least one of:
removing the pawn/key from the geographical region
touching the illuminated geographical region using a finger/stylus
switching off the globe.

8. The interactive ambience creating system as claimed in claim 1, further comprising:
a sun sphere coupled with the touch sensitive globe, the sun sphere being smaller in size compared to the touch sensitive globe and disposed on a rotation axis parallel to the rotation axis of the touch sensitive globe and substantially away from the touch sensitive globe and wherein
the information processing unit is further configured to determine the position of the sun sphere in relation to the touched geographical region and obtain information related to the time of the day/night; and
the control unit is further configured to adapt at least one output device to create an ambience representing the obtained time of the day/night.

9. The interactive ambience creating system as claimed in claim 8, wherein positioning the touch sensitive globe or the sun sphere such that the touched geographical region is behind the sun sphere activates the control unit to create an ambience that represents night.

10. The interactive ambience creating system as claimed in claim 1, wherein the information processing unit is further configured to manually receive additional information from the user and the control unit is further configured to adapt at least one output device and create an ambience based on i) the information obtained corresponding to the touched geographical region and ii) manually received additional information from the user.

11. The interactive ambience creating system as claimed in claim 1, wherein the touch sensitive globe is configured as a two dimensional electronic mat or as a two dimensional touch screen coupled with a detachable pawn to select a geographical region and generate the signal representing the selected geographical region.

12. An interactive ambience creating method comprising:
employing a touch sensitive globe and generating a signal representing a geographical region based on touch by a user;
receiving the generated signal and obtaining information corresponding to the touched geographical region; and
activating at least one output device in accordance with the obtained information to create an ambience corresponding to the touched geographical region.

13. A software program comprising an executable code stored on a non-transitory computer readable medium which when executed by a processor performs the method of claim 12.
